(19) United States
(12) Patent Application Publication
(10) Pub. No.: US 2024/0393919 A1
(43) Pub. Date: Nov. 28, 2024

(54) OBJECT SELECTION FROM MULTIPLE CANDIDATES

(71) Applicant: Apple Inc., Cupertino, CA (US)

(72) Inventors: Andrew Muehlhausen, Seattle, WA (US); Elena J. Nattinger, Menlo Park, CA (US); Devin W. Chalmers, Oakland, CA (US); Paul Ewers, San Jose, CA (US); Paulo R. Jansen dos Reis, San Jose, CA (US); Peter Burgner, Venice, CA (US); Christopher D. Fu, Fremont, CA (US); Richard P. Lozada, Cupertino, CA (US)

(21) Appl. No.: 18/666,021

(22) Filed: May 16, 2024

Related U.S. Application Data
(60) Provisional application No. 63/468,215, filed on May 22, 2023.

(51) Int. Cl. G06F 3/0482; G06F 3/01; G06F 3/04817; G06F 3/16

(52) U.S. Cl. CPC G06F 3/0482; G06F 3/013; G06F 3/04817; G06F 3/167

(57) ABSTRACT

Systems and methods for facilitating selection of a target object required by a request from a user from a set of candidate objects include identifying the set of candidate objects in a gaze region corresponding to a gaze of the user and generating a graphical user interface allowing a user to select the target object from the set of candidate objects.

### CROSS-REFERENCE TO RELATED APPLICATIONS

This application is a nonprovisional and claims the benefit under 35 U.S.C. 119(e) of U.S. Provisional Patent Application No. 63/468,215, filed May 22, 2023, the contents of which are incorporated herein by reference as if fully disclosed herein.

### TECHNICAL FIELD

Embodiments described herein relate to systems and methods for facilitating the selection of a target object from a number of candidate objects identified by an electronic device.

### BACKGROUND

Electronic devices may be configured to provide extended reality experiences in which a user can interact with both real-world objects in the physical environment and computer-generated visual elements. In doing so, the electronic device may need to identify a particular object in the physical environment the user intends to interact with, which may be difficult in situations wherein multiple objects are present.

### SUMMARY

In one embodiment, a method of operating an electronic device includes identifying a request from a user of the electronic device. The request may require a target object in a field of view of a camera of the electronic device. In response to the request, a gaze region in the field of view corresponding to the gaze of a user may be determined. A set of candidate objects located in the gaze region may be identified. A graphical user interface may be generated at a display allowing the user to select the target object from the set of candidate objects. User input selecting the target object from the set of candidate objects may be received. The request may be performed with respect to the target object.

In one embodiment, the request may be a voice command from a user.

In one embodiment, identifying the set of candidate objects may include identifying a plurality of objects in the gaze region and selecting the set of candidate objects from the plurality of objects based on a selection criteria. The selection criteria may include a proximity of an object to the electronic device and/or a context associated with the request. In one embodiment, the request specifies an object type of the target object and the selection criteria is a determination whether a type of an object matches the specified object type.

In one embodiment, a determination may be made if the target object can be identified in the set of candidate objects. In response to a determination that the target object can be identified, the request may be performed with respect to the target object. In response to a determination that the target object cannot be identified, the graphical user interface may be generated.

In one embodiment, the graphical user interface includes a set of selectable icons, each corresponding to one of the set of candidate objects. At least one of the selectable icons may include an image of the corresponding one of the set of candidate objects taken by the camera. At least one of the selectable icons may include an image chosen from a plurality of images in a database based on the corresponding one of the set of candidate objects. At least one of the selectable icons may include a shape based on a shape of the corresponding one of the set of candidate objects.

In one embodiment, an electronic device includes a gaze tracker, a display, and a processor operably coupled to the gaze tracker and the display. The gaze tracker may be configured to detect a gaze of a user within a gaze field of view. The display may have a display area positioned to overlap at least a portion of the gaze field of view. The processor may be configured to identify a request from a user, the request requiring a target object in the gaze field of view. In response to the request, the processor may be configured to determine a gaze region in the gaze field of view corresponding to the gaze of the user, identify a set of candidate objects located in the gaze region, determine a level of overlap between the gaze region and the display area, select a graphical user interface from a plurality of graphical user interfaces based on the level of overlap between the gaze region and the display area, the graphical user interface allowing the user to select the target object from the set of candidate objects, and display the graphical user interface at the display.

In one embodiment, the graphical user interface may include a set of selectable icons each corresponding to a candidate object of the set of candidate objects and positioned to overlay a portion of the corresponding candidate object that is positioned within the display area.

In one embodiment, the graphical user interface may include a set of selectable icons each corresponding to a candidate object of the set of candidate objects and positioned within the display area at a predefined location.

In one embodiment, the graphical user interface may include a set of selectable icons each corresponding to a candidate object of the set of candidate objects. A first one of the set of selectable icons may be positioned to overlay a portion of the corresponding candidate object that is positioned within the display area. A second one of the set of selectable icons may be positioned at a predefined location in the display area. The first one of the selectable icons may correspond to a first one of the candidate objects positioned within the display area. The second one of the selectable icons may correspond to a second one of the candidate objects positioned outside the display area.

In one embodiment, the electronic device may further include a camera. At least one of the selectable icons may include an image of the corresponding one of the set of candidate objects taken by the camera. At least one of the selectable icons may include an image chosen from a plurality of images in a database based on the corresponding one of the set of candidate objects. At least one of the selectable icons may include a shape based on a shape of the corresponding one of the set of candidate objects.

In one embodiment, identifying the set of candidate objects may include identifying a plurality of objects in the gaze region and selecting the set of candidate objects from the plurality of objects based on a selection criteria. The selection criteria may include a proximity of the object to the electronic device and/or a context associated with the request.

In one embodiment, a method of operating an electronic device may include identifying a request from a user of the electronic device, the request requiring a target object in a field of view of a camera of the electronic device. In response to the request, a candidate object may be identified based on a gaze of the user, a set of candidate parts of the candidate object may be identified, a graphical user interface may be generated at a display of the electronic device, the graphical user interface allowing the user to select the target object from the set of candidate parts, user input may be received selecting the target object from the set of candidate parts, and the request may be performed with respect to the target object.

In one embodiment, a first candidate part of the set of candidate parts may be the candidate object and a second candidate part of the set of candidate parts may be a portion of text on the candidate object. A third candidate part may be a picture on the candidate object.

In one embodiment, a first candidate part of the set of candidate parts may be the candidate object and a second candidate part of the set of candidate parts may be a picture on the candidate object.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified block diagram of an electronic device, such as described herein.

FIG. 2 depicts a diagram illustrating an example relationship between a camera field of view, a gaze field of view, and a display area for the electronic device, such as described herein.

FIGS. 3A-3E depict a portion of a physical environment from the perspective of the electronic device, such as described herein.

FIGS. 4A-4C depict a portion of a physical environment from the perspective of the electronic device, such as described herein.

FIG. 5 is a flowchart depicting example operations of a method for performing a request from a user requiring a target object, such as described herein.

FIG. 6 is a flowchart depicting example operations of a method for generating a graphical user interface, such as described herein.

FIG. 7 is a flowchart depicting example operations of a method for performing a request from a user requiring a target object that is part of another object, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein are related to systems and methods for selecting a target object from a number of candidate objects identified by an electronic device. As discussed above, electronic devices may be configured to provide extended reality experiences in which a user can interact with both real-world objects in the physical environment and computer-generated visual elements. As part of an extended reality experience or otherwise, the electronic device may be configured to perform actions on behalf of the user requiring a target object. Before the action can be performed, the target object must be identified. However, it may not be clear which portion of the user's environment is intended to be the target object. Accordingly, it may be useful to clarify the user's intent. Systems and methods of the present application are configured to clarify user intent, and in particular to identify one or more target objects.

As an example, a user may provide a request related to a target object in the physical environment to the electronic device. In particular, the request may be a voice command, such as the phrase “tell me about that,” where “that” refers to an object in the physical environment the user is looking at. In addition to requests for information, the request may be a command such as “turn this off,” a reminder prompt such as “next time I see this, remind me to put it away,” or any other type of request. As another example, a user may point to an object in the physical environment. As yet another example, a user may look at and/or focus on an object in the physical environment. The request may be a one-off request such as those discussed above or a standing request performed every time some event occurs. For example, a user may request “every time I see this, remind me to call Bill.”

The electronic device may be configured to identify objects in the physical environment, for example, via a camera or set of cameras. In particular, the electronic device may be configured to identify objects within a field of view of the camera or set of cameras. The electronic device may include a gaze tracker configured to identify a gaze region in the field of view corresponding to a gaze of the user, where the gaze region may be a subset of the field of view. To identify the target object, the electronic device may be configured to identify a set of candidate objects at least partially located in the gaze region at or around the time of the request. In cases wherein there is only one candidate object in the gaze region, or when a context of the request or other information provides a clear indication of the target object, the request may be performed with respect to the target object. Following the example above, the electronic device may identify the target object as a plant the user is looking at, and provide information to the user about the plant (e.g., a size of the plant, a watering status of the plant, care instructions for the plant, information about the species of the plant, or the like). However, in many cases the gaze region will include multiple candidate objects, and it will not be clear which of the candidate objects is the target object.

To facilitate selection of the target object from the set of candidate objects, a graphical user interface may be generated at a display of the electronic device, the graphical user interface allowing a user to select the target object from the set of candidate objects. The display may be transparent or semi-transparent in some embodiments such that a portion of the physical environment may be viewable through the display. The graphical user interface may differ based on whether or not the candidate objects are viewable through the display. For example, when a candidate object is viewable through the display, a selectable graphical element such as a selectable icon may be positioned in the display area to be overlaid on the candidate object. The selectable icon may be, for example, a shape corresponding to a shape of the candidate object, an image of the candidate object taken by the camera or set of cameras, or an image selected from a database of images based on the candidate object. When a candidate object is not viewable through the display, a selectable graphical element may be positioned at a predefined location on the display, such as at a center of the display.

Upon receipt of user input selecting the target object from the candidate objects, the electronic device may perform the request with respect to the target object. For example, the user may select the plant as discussed above from a set of candidate objects including, for example, the plant, a water bottle, and a toy truck. The electronic device may provide information about the plant as discussed above. The user input may be, for example, a change in the gaze of the user, a voice command from the user, movement of the user, a gesture from the user, interaction with a user input mechanism of the electronic device, or the like.

In some cases, the target object may be part of a larger object. For example, the request “tell me about that,” may refer to an apple in a bowl of fruit, the bowl including the fruit, a book, a selection of text in a book, a picture in a book, or the like. Accordingly, in some embodiments the electronic device may be configured to identify a candidate object based on the gaze of the user, and identify a set of candidate parts of the candidate object. The electronic device may facilitate selection of the target object from the set of candidate parts as discussed above.

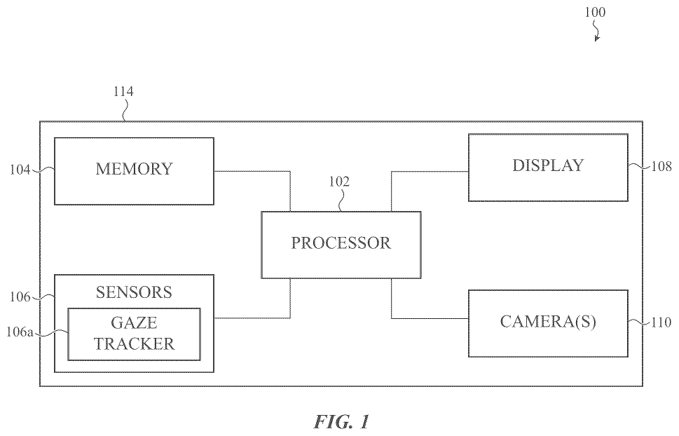

These foregoing and other embodiments are discussed below with reference to FIGS. 1-7. However, those skilled in the art will readily appreciate that the detailed description given herein with respect to these figures is for explanation only and should not be construed as limiting.

FIG. 1 is a simplified block diagram of an electronic device 100 according to one embodiment of the present disclosure. The electronic device 100 includes a processor 102, a memory 104, a number of sensors 106 including at least a graze tracker 106a, a display 108, and one or more cameras 110. The memory 104, the number of sensors 106, the display 108, and the one or more cameras 110 may be operably connected to the processor 102. The memory 104 may include instructions, which, when executed by the processor 102 cause the electronic device 100 to perform the operations discussed herein to identify a request from a user requiring a target object, facilitate selection of the target object from a set of identified candidate objects and/or parts, and perform the request with respect to the target object. In some embodiments, the electronic device 100 may be a head-mounted device such as an extended reality headset, smart glasses, or the like. However, the principles of the present disclosure apply to electronic devices having any form factor.

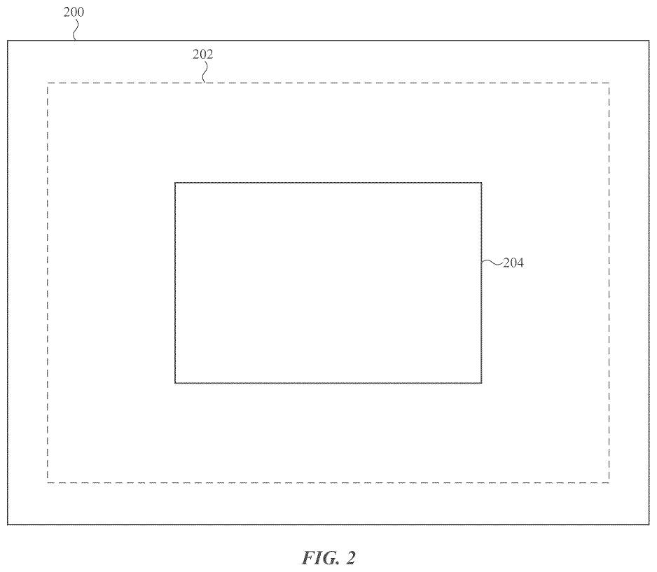

FIG. 2 is a diagram illustrating an example relationship between an object detection field of view 200, a gaze field of view 202, and a display area 204 of the electronic device 100 discussed above with respect to FIG. 1. The object detection field of view 200 may correspond to the boundaries of the environment in which the electronic device 100 is able to perceive and/or identify objects. For example, the object detection field of view 200 may correspond with a field of view of the one or more cameras 110 of the electronic device 100, or a combination of a field of view of the one or more cameras 110 and one or more other sensors such as one or more depth sensors (e.g., a time of flight sensor or the like), or any other sensors that may assist with detecting and/or identifying objects in the physical environment. The gaze field of view 202 may correspond to the area over which a gaze of the user can be tracked. In some embodiments, this may correspond with the area over which the location of the gaze of the user can be determined with a desired accuracy. The gaze field of view 202 may represent all or a subset of the user's full gaze range for a given head position. As shown, the gaze field of view 202 may be a subset of the object detection field of view 200, however, this is not required. In some cases, the gaze field of view 202 may be the same size as or larger than the object detection field of view 200. The display area 204 may correspond to an area within the object detection field of view 200 and the gaze field of view 202 on which a graphical user interface is overlaid as viewed by a user of the electronic device 100 (e.g., when the electronic device 100 is worn as a head mounted device). In some cases, the display area 204 may correspond to the physical boundaries of the display 108 of the electronic device 100. As shown, the display area 204 may be smaller than both the object detection field of view 200 and the gaze field of view 202. However, this is not required, and the display area 204 may be the same size or larger than the object detection field of view 200 and/or the gaze field of view 202. The display 108 may be at least partially transparent, such that the physical environment is viewable through the display area 204, and graphical elements can be overlaid on the physical environment within the display area 204.

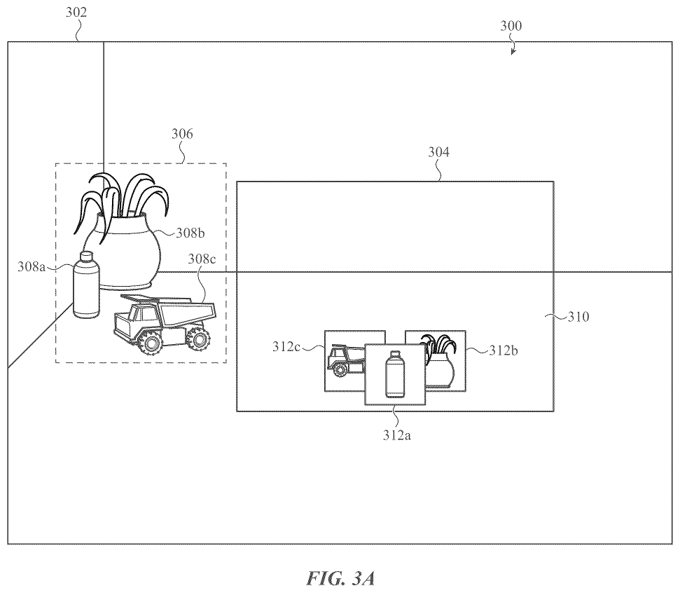

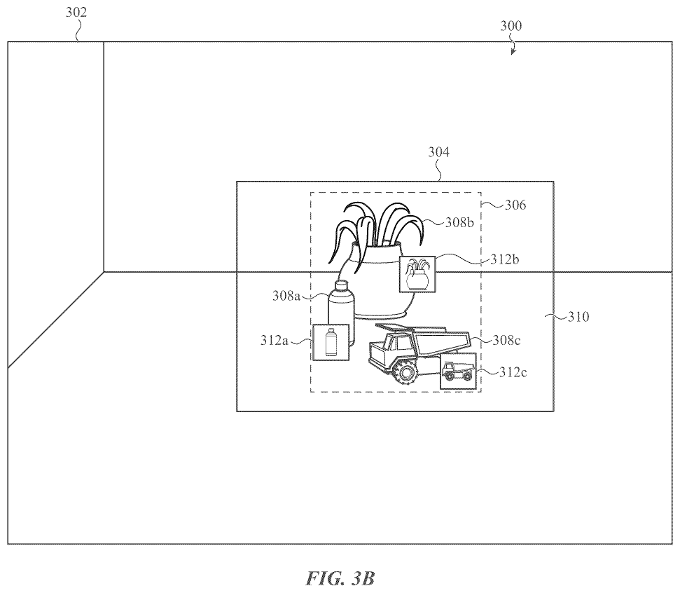

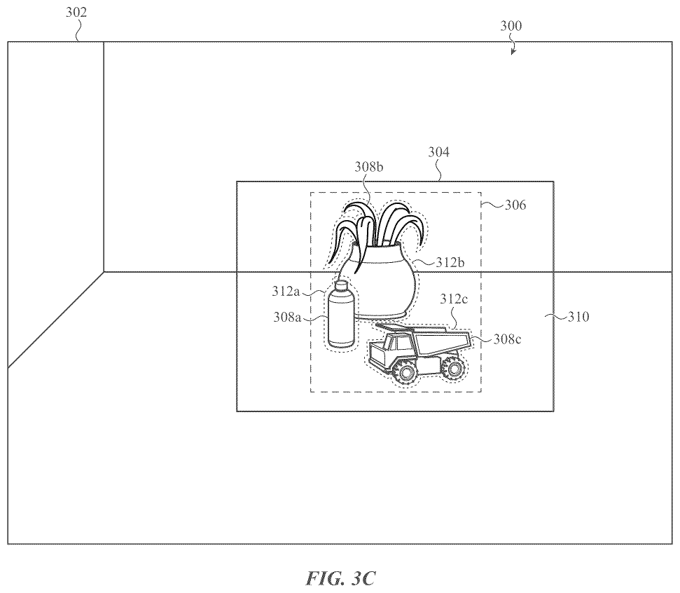

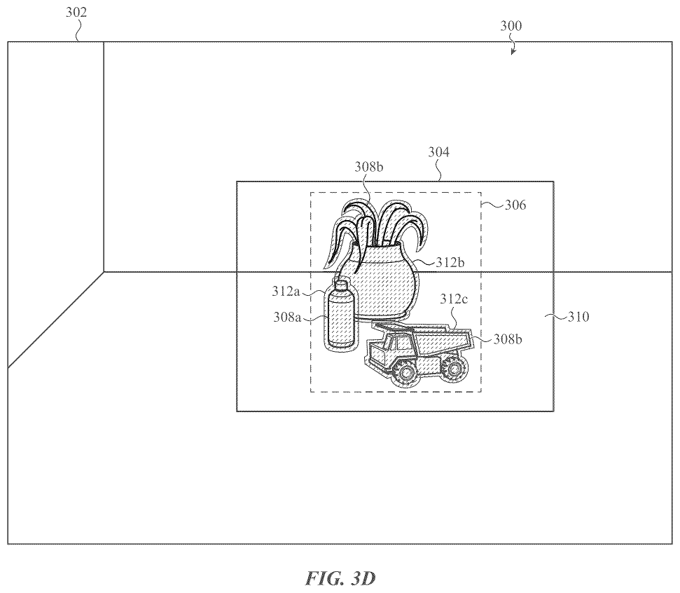

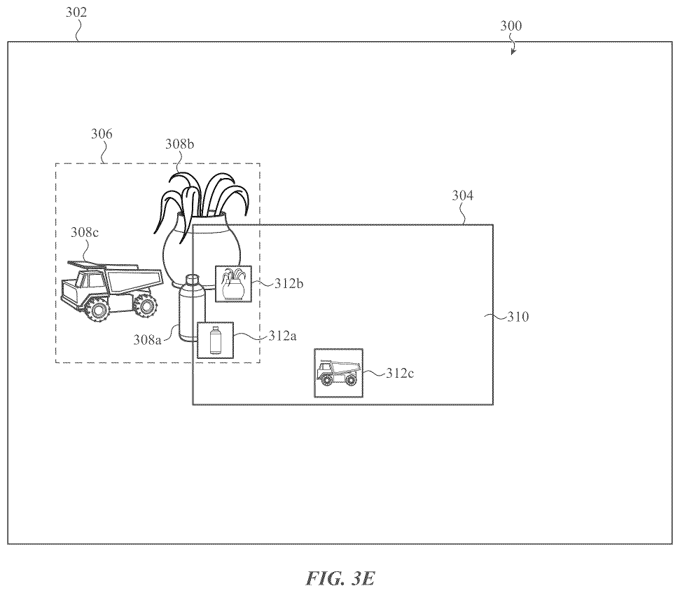

FIG. 3A illustrates a portion of a physical environment 300 from the perspective of the electronic device 100 discussed above with respect to FIG. 1. In particular, a portion of the physical environment 300 within a camera field of view 302 is shown. While not shown, a gaze field of view may be partially or completely overlapping with the camera field of view 302. A display area 304 is also shown within the camera field of view 302. A gaze region 306 is also shown within the camera field of view 302. The gaze region 306 may be identified by the electronic device 100 in response to identifying a request from the user requiring a target object, periodically, or in response to any other action. The gaze region 306 may be identified based on a region of the object detection field of view 300 being looked at by the user the time of the request, a history of the user's gaze before, during, and/or after the request, or otherwise. A size of the gaze region 306 may be based on any number of factors including, for example, how long the gaze of the user lingered in the gaze region 306, accuracy constraints of the gaze tracker 106a, or any other information about the gaze of the user.

As shown, the gaze region 306 includes a number of objects positioned at least partially therein. As discussed in further detail below, the electronic device 100 may be configured to identify these objects as candidate objects related to a request from the user requiring a target object. Following the example discussed above, the user may say “tell me about that” while looking towards the gaze region 306. The electronic device 100 may thus identify the objects within the gaze region 306 as candidate objects 308 related to the request. As shown, the gaze region 306 includes a first candidate object 308a, a second candidate object 308b, and a third candidate object 308c.

Without more information, the electronic device 100 may be unable to discern which one of the candidate objects 308 is the target object for the request. Accordingly, the electronic device may present a graphical user interface 310 within the display area 304 including a selectable graphical element 312 for each of the candidate objects 308. The selectable graphical elements 312 may allow the user to clarify which object was intended as the target action by selecting a corresponding graphical element. For example, the graphical user interface 310 may include a first selectable graphical element 312a corresponding to a first candidate object 308a (depicted as a water bottle), a second selectable graphical element 312b corresponding to a second candidate object 308b (depicted as a plant), and a third selectable graphical element 312c corresponding to a third candidate object 308c (depicted as a toy truck). In the current example, the selectable graphical elements 312 are selectable icons, each representing a corresponding candidate object 308. The selectable icons may include a picture of the corresponding candidate object 308, an image selected from a database of images based on the corresponding candidate object 308, a shape corresponding to a shape of the corresponding candidate object 308, or any other suitable representation of the corresponding candidate object 308.

In the case that the selectable icon includes a picture of the corresponding candidate object 308, the picture may be a cropped portion of an image captured by the one or more cameras 110 of the electronic device 100. In the case that the selectable icon includes an image selected from a database of images selected based on the corresponding candidate object 308, the electronic device 100 may be configured to recognize a type of the corresponding candidate object 308 and select a representative image, icon, or other graphic from the database based on the recognized object type. For example, the first selectable graphical element 312a corresponding to the first candidate object 308a, which is illustrated as a water bottle, may be represented by an icon including a picture of the water bottle, an image or illustration of a water bottle selected from a database of images, or a shape of the water bottle.

A user may interact with the electronic device 100 to select one of the selectable graphical elements 312 and thus the target object from the set of candidate objects 308. The selection may be performed in any suitable manner, such as by a voice command, gesture, change in gaze, or interaction with a dedicated user input mechanism. The electronic device 100 may then perform the request with respect to the target object, such as providing more information about the target object via updates to the graphical user interface 310 or otherwise. The graphical user interface 310 and/or the selectable graphical elements 312 may change in response to user input, such as changes in the gaze of the user, to indicate, for example, which one of the selectable graphical elements 312 is currently being selected. For example, as a user looks at a particular one of the selectable graphical elements 312, the selectable graphical element 312 may grow in size, change color, or be accentuated or highlighted in any other manner.

In some instances, one of the selectable graphical elements 312 may be presented with one of the graphical elements currently selected (e.g., as a “default” selection that may initially be presented with one or more characteristics, such as size or color, that is different relative to the other graphical elements 312 in order to accentuate or highlight the default selected graphical element. The user may be able to confirm the default selected graphical element with a predetermined action (e.g., a gesture, voice input, or the like), in which case the candidate object associated with the default selected graphical element becomes the target object, or may change the current selection to another graphical element as discussed above. The default selection may be determined by the system using one or more criteria, and may represent the candidate object that the system thinks is the most likely choice.

While not shown, additional objects in the physical environment 300 may be present outside of the gaze region 306. Since the user is not looking at these objects when making the request, they may not be identified as candidate objects by the electronic device 100. Additionally, in some cases objects within the gaze region 306 may not be identified as candidate objects. For example, the electronic device 100 may identify a plurality of objects within the gaze region 306, and subsequently select the candidate objects 308 from the plurality of objects based on a selection criteria. In some cases, this may result in a subset of the plurality of objects being selected as the candidate objects 308. The selection criteria may include a proximity of an object to the electronic device 100, a size of an object, a context of the request from the user, or any other information.

Specifically, in some of these variations the selection criteria may include proximity of objects relative to the electronic device 100 when selecting candidate objects. In these instances, the proximity of a given object to the electronic device 100 may at least partially determine whether that object is selected as a candidate object 308. For example, a respective proximity may be measured for each of the plurality of objects within the gaze region 306 (e.g., collectively forming a plurality of proximity measurements). The plurality of proximity measurements may be compared to a set of threshold distances in determining which of the plurality of objects is selected as a candidate object. In some instances, each of the proximity measurements may be compared to the same threshold distance (e.g., any object that is further than a first threshold distance may not be identified as a candidate object 308). In other instances, different proximity measurements may be compared to different threshold distances (e.g., a first proximity measurement corresponding to a first object is compared to a first threshold distance and a second proximity measurement corresponding to a second object is compared to a second threshold distance). For example, the threshold distance selected for a given proximity measurement may depend on the type object and/or the location of the object within the gaze region 306.

Using the physical environment 300 as an example, the plant in the physical environment 300 may be further away from the electronic device 100 than the water bottle or the toy truck, and thus may not be identified as a candidate object 308 in some cases. Specifically, the plant may be more than a threshold distance from the electronic device 100, where the threshold distance is statically or dynamically defined based on the number and position of identified objects in the gaze region 306.

In another example, the electronic device 100 may be configured to determine a context associated with the request. In these instances, the determined context may limit the type of objects that may be selected as candidate objects. Accordingly, the electronic device 100 may use the determined context to set one or more object characteristics, and only select objects that meet these object characteristics when selecting the candidate objects. In some instances, the request from the user may specify or otherwise be associated with a particular type of object, such that only objects identified to be that type of object are used as candidate objects. For example, a user may provide a request to “tell me more about that toy,” in which case the electronic device 100 may set “toys” as an object characteristic for selecting the candidate object (e.g., all objects not identified as toys may be ruled out as candidate objects). In another instance, the request from the user may specify or otherwise be associated with a particular feature or capability of an object. For example, a user may ask the question “How do I turn that on?”, in which instance the determined object characteristic may be objects that have on and off states.

In some instances, the selection criteria may be based on recent requests from the user or other information derived from the physical environment 100. For example, when determining the context associated with the request, the electronic device may use previous requests in determining this context. In these instances, a user's previous requests may provide an indication of a user's intention for the current request. For example, if a user has been asking a series of questions about plants, then says “tell me more about that,” while looking at a number of plants and other objects, only the plants may be selected as candidate objects 308 for the request. In other instances, when determining the context associated with the request, the electronic device 100 may use information of the physical environment 100 outside of the gaze region 306. For example, the user may ask “which of these is the most valuable?”

Notably, FIG. 3A shows both the gaze region 306 and the candidate objects 308 completely outside of the display area 304 such that none of the candidate objects 308 are viewable through the display area 304. In this example, the selectable graphical elements 312 for each of the candidate objects 308 are displayed at a predefined location within the display area 304, such as near the bottom thereof and towards the center as shown. However, the selectable graphical elements 312 may be displayed at any predefined location within the display area 304 or at a location in the display area 304 determined based on a relative location of the corresponding candidate object 308 in relation to the display area 304, another candidate object 308, or any other reference point.

FIG. 3B shows the portion of the physical environment 300 from a different perspective wherein the gaze region 306 is within the display area 304 such that the candidate objects 308 are viewable through the display area 304. The graphical user interface 310 shown in FIG. 3B is similar to that shown in FIG. 3A, except that the selectable graphical elements 312 are positioned in the display area 304 to be at least partially overlaid on the corresponding candidate objects 308. In particular, a position of each of the selectable graphical elements 312 may be selected based on a relative position of the corresponding candidate object 308. Depending on the number and relative proximity of candidate objects 308 in the display area 304 and/or gaze region 306, it may not be feasible to overlay a selectable graphical element 312 on a particular candidate object 308. For example, if a first candidate object 308 is positioned to block a significant portion of a second candidate object 308, it may not be feasible to overlay a selectable graphical element 312 on the second candidate object 308. In such cases, the selectable graphical element 312 may not be overlaid on the corresponding candidate object 308, but rather may be positioned near the corresponding candidate object 308.

In some instances, the placement of these graphical elements 312 may be specifically selected such that the spacing between the graphical element 312 is larger than the spacing between the candidate objects. For example, the first graphical element 312a and the second graphical element 312b may be positioned such that a distance between these elements is larger than the distance between the first candidate object 308a and the second candidate object 308b (e.g., the distance between the centers of these candidate objections). By having a larger distance between graphical elements, it may be easier for the systems and devices described herein to use a user's gaze to determine which graphical element the user is currently looking at. This in turn may allow the user to use their gaze to select the target object from the candidate objections, and may improve the confidence of the gaze determination.

FIG. 3C shows the portion of the physical environment 300 from the same perspective as in FIG. 3B. However, the graphical user interface 310 in FIG. 3C is different from that shown in FIG. 3B such that instead of selectable icons, the selectable graphical elements 312 are outlines overlaid on the corresponding candidate objects 308. The outlines may correspond to the visible portion of the candidate objects 308. For example, as shown the first candidate object 308a partially occludes the second candidate object 308b. The outline overlaid on the second candidate object 308b may correspond only with the visible portion thereof, and not include the occluded portion. In some cases wherein a candidate object 308 is partially covered by another object which is not a candidate object, the outline may include part of the overlapping object (e.g., to approximate the overall shape of the candidate object 308). In one example, a user may interact with the outlines (e.g., by looking within the outlined area) in order to select the corresponding candidate object 308.

FIG. 3D shows the portion of the physical environment 300 from the same perspective as in FIG. 3B. However, the graphical user interface 310 in FIG. 3D is different from that shown in FIG. 3B such that instead of selectable icons, the selectable graphical elements 312 are shapes overlaid on the corresponding candidate objects 308, each corresponding to the shape (or a visible portion of the shape) of the corresponding candidate object 308. In some of these instances, the shapes overlaid on the corresponding candidate objects 308 may block visibility of the underlying candidate objects 308. In other instances, the shapes overlaid on the corresponding candidate objects 308 may still allow for visibility of the underlying candidate objects 308, but modifies the appearance of the candidate objects 308. For example, the shapes overlaid on the corresponding candidate objects 308 may act to highlight the candidate objects. In some of these instances, different shapes overlaid on the corresponding candidate objects 308 may provide highlighting to the underlying candidate objects, by changing the color, brightness and/or contrast of the different candidate objects 308. For example, the electronic device 100 may apply a first color transformation to a first candidate object (e.g., to apply a first tint, such as a green tint, to the first candidate object) and may apply a second color transformation to a second candidate object (e.g., to apply a second tint, which may be the same color as or a different color from the first tint, to the second candidate object). In some variations, one or more aspects of the shapes overlaid on the corresponding candidate objects 308 may change in response to user input, such as changes in the gaze of the user, to indicate, for example, which one of the candidate objects 308 is currently being selected. For example, as a user looks at a particular one of the candidate objects 308, the shape overlaid on that candidate object 308 may grow in size, change color (e.g., change the color transformation applied to the candidate object), or otherwise be modified to change the highlighting provided by the shape to the underlying candidate object 308.

FIG. 3E shows the portion of the physical environment 300 from a different perspective wherein the gaze region 306 partially overlaps the display area 304 such that some of the candidate objects 308 are at least partially viewable through the display area 304 while the remainder are outside the display area 304. The graphical user interface 310 shown in FIG. 3E is similar to that shown in FIGS. 3A and 3B, except that some of the selectable graphical elements 312 (specifically, the first selectable graphical element 312a and the second selectable graphical element 312b) are positioned in the display area 304 to be overlaid on the corresponding object while the remaining selectable graphical elements 312 (specifically, the third selectable graphical element 312c) are positioned at a predefined location in the display area 304. In particular, the selectable graphical elements 312 corresponding to a candidate object 308 viewable through the display area 304 are positioned in the display area 304 to overlay the corresponding candidate object 308, while the selectable graphical elements 312 corresponding to a candidate object 308 outside the display area 304 are positioned at a predefined location in the display area 304.

In the examples discussed above, the objects were identified by their physical boundaries. However, there may be times where a user only wishes to specify a portion of an object (i.e., a target object is a part of a larger object), such as a picture in a book or a selection of text in a book. For example, while looking at an open book, a user may request “tell me more about that.” Given the context, it may be unclear whether the user is talking about the book itself, a picture in the book, or a selection of text in the book. As another example, a user may make the same request while looking at a bowl of fruit. Given the context, it may be unclear whether the user is talking about the bowl, a piece of fruit in the bowl, or the bowl including the fruit. Accordingly, it may be desirable in some situations to identify portions or parts of an object as candidate objects.

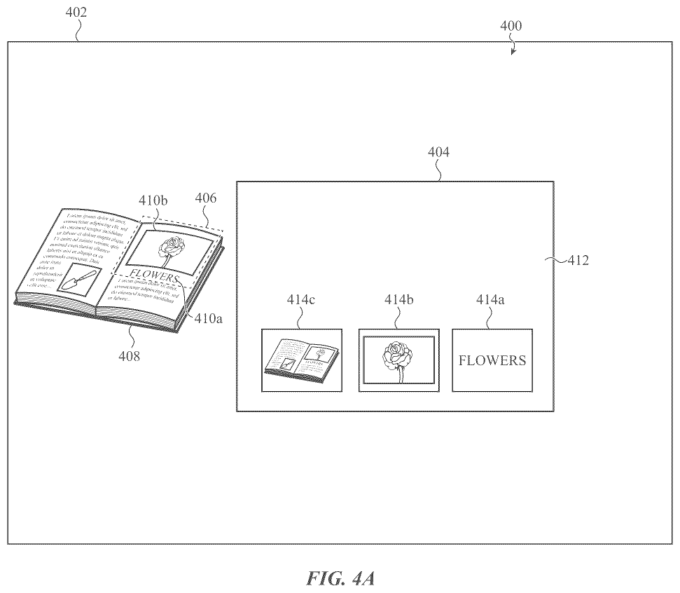

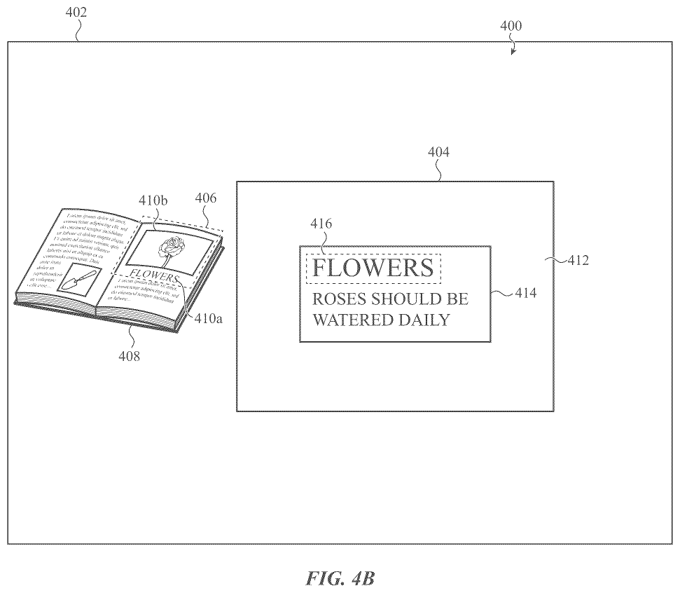

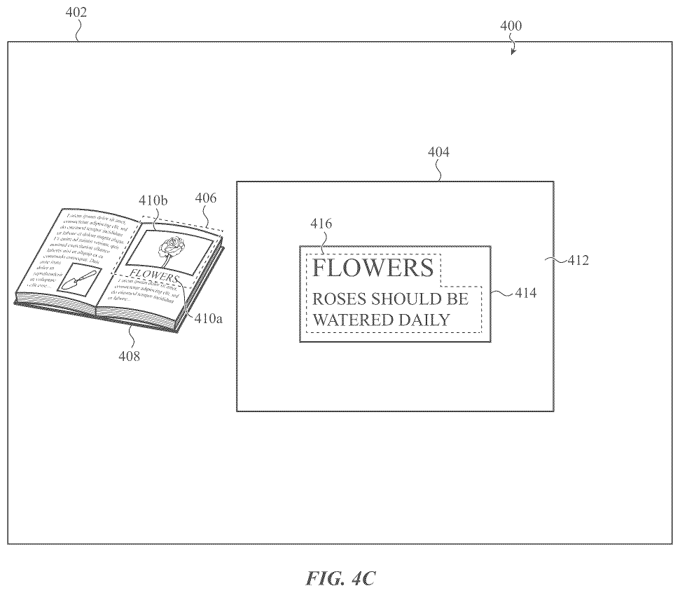

FIG. 4 illustrates a portion of a physical environment 400 from the perspective of the electronic device 100 discussed above with respect to FIG. 1. In particular, a portion of the physical environment 400 within a camera field of view 402 is shown. While not shown, a gaze field of view may be partially or completely overlapping with the camera field of view 402. A display area 404 and a gaze region 406 are also shown within the camera field of view 402, the gaze region 406 corresponding to a region of the camera field of view 402 currently being looked at by a user. As shown, the gaze region 406 includes a portion of an object. As discussed in further detail below, the electronic device 100 may be configured to identify the object as a candidate object related to a request from the user requiring a target object. Following the example discussed above, the user may say “tell me more about that” while looking towards the gaze region 406. The electronic device 100 may thus identify the object within the gaze region 406 as a candidate object 408 related to the request.

Without more information, the electronic device 100 may be unable to discern whether the request requires the candidate object 408 or a part thereof. Accordingly, the electronic device 100 may be further configured to identify multiple candidate parts 410 of the candidate object 408, each of which may be considered a separate candidate for the target object. As shown, the candidate object 408 includes a first candidate part 410a (e.g., a selection of text) and a second candidate part 410b (e.g., a picture). The electronic device 100 may present a graphical user interface 412 within the display area 404 including a selectable graphical element 414 for each of the set of candidate parts 410 (e.g., a first graphical element 414a corresponding to the first candidate part 410a and a second graphical element 414b corresponding to the second candidate part 410b). Notably, the candidate parts 410 may include the candidate object 408 itself, and may include a graphical element (e.g., third graphical element 414c) corresponding to the candidate object 408. As discussed above, the selectable graphical elements 414 may be selectable icons having an image of the corresponding part, an image selected from a database of images based on the corresponding candidate part, a shape based on a shape of the corresponding candidate part, or the like. Further as discussed above, a user may interact with the electronic device 100 to select one of the selectable graphical elements 414 and thus the target object from the set of candidate parts 410. The electronic device 100 may then perform the request with respect to the target object. While not shown, the electronic device 100 may be configured to identify multiple candidate objects, and multiple candidate parts of at least one of the multiple candidate objects. That is, the electronic device 100 may be configured to identify at least two candidate objects and at least two candidate parts of at least one of the candidate objects.

In some situations, it may be desirable to provide granular control over selection of a target object. For example, a request may receive text as a target object, such as when a user selects the graphical element 414a corresponding to the first candidate part 410a in the example discussed above with respect to FIG. 4A. In response, the electronic device 100 may select a default amount of text (e.g., a word, a sentence, a paragraph, etc.) for the request, but the user may wish to expand or reduce the default selection. FIGS. 4B and 4C illustrate the portion of the physical environment 400 as in FIG. 4A, but with a graphical user interface 412 allowing for granular selection of a target object. As shown, the graphical user interface 412 shows a candidate part 414 including a granular selection graphical element 416. The user may interact with the electronic device 100, for example, by changing their gaze, moving, speaking, gesturing, or interacting with a user input mechanism thereof to expand or contract the granular selection graphical element 416. In the present example, the user may interact with the electronic device 100 to increase or decrease the number of words selected, the selected words being the target object. In particular, FIG. 4B shows the granular selection graphical element 416 including a single word, while FIG. 4C shows the granular selection graphical element 416 including a number of words. While illustrated in the context of a selection of text, granular selection may be useful in other situations as well.

Returning to the exemplary fruit bowl discussed above, granular selection may be provided to select a single piece of fruit, multiple pieces of fruit, the bowl, the bowl including the fruit, etc. in a similar manner. Following this example, the graphical user interface 412 may show or highlight a particular candidate part such as a piece of fruit including a granular selection graphical element, such as, for example, a border around the piece of fruit. The user may interact with the electronic device 100, for example, by changing their gaze, moving, speaking, gesturing, or interacting with a user input mechanism thereof to expand or contract the granular selection graphical element to cover additional pieces of fruit, the entire fruit bowl, etc. Further, granular selection may be used in the context of multiple candidate objects where a request requires a set of target objects.

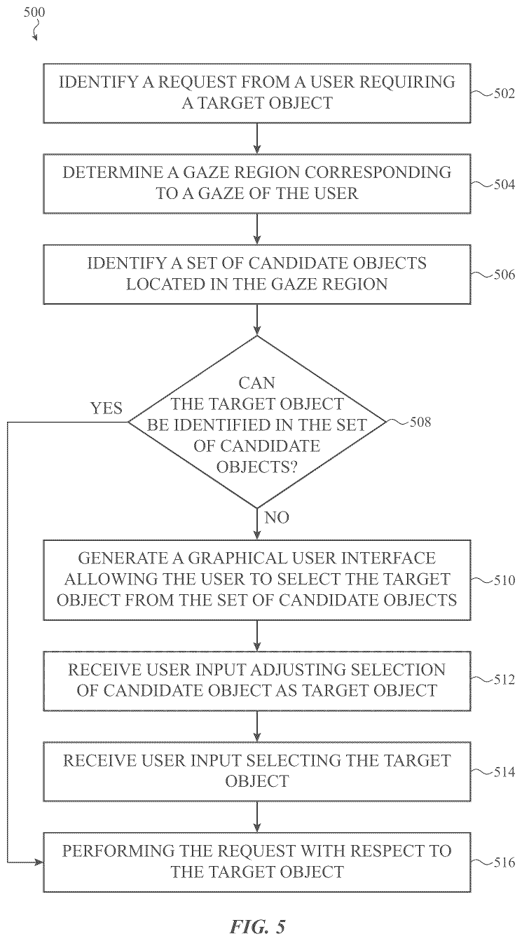

FIG. 5 is a flowchart depicting example operations of a method 500 for performing a request from a user requiring a target object. The operations may be performed, for example, by the electronic device 100 discussed above with respect to FIG. 1. At block 502, a request from a user requiring a target object may be identified. Identifying the request may include analyzing sensor data from one or more sensors. For example, identifying the request may include analyzing voice signals from a microphone to identify a verbal request from the user. As another example, identifying the request may include analyzing images from one or more cameras to identify gestures from the user. As another example, identifying the request may include analyzing motion data from a motion sensor to identify movements of the user. Generally, the request may be identified in any suitable manner. Identifying the request may be performed locally at an electronic device or in conjunction with one or more remote devices such as one or more remote servers to the electronic device.

At block 504, a gaze region corresponding to a gaze of the user may be determined. As discussed above, the gaze region is a region in a physical environment the user is looking towards. The gaze region may be determined based on information from a gaze tracker, which may be any suitable type of gaze tracking hardware. In one example, the gaze tracker may be one or more cameras configured to follow the eye movements of the user.

At block 506, a set of candidate objects located in the gaze region may be identified. The set of candidate objects may be identified, for example, using one or more cameras. For example, the set of candidate objects may be identified using computer vision techniques performed on images and/or video from the one or more cameras. The one or more cameras may have a camera field of view corresponding to the portion of the physical environment that can be imaged by the one or more cameras. The gaze region may be a subset of the camera field of view. The gaze region may be searched in one or more images or videos taken by the one or more cameras to identify the set of candidate objects. In some cases, the set of candidate objects is only a subset of all of the objects identified in the gaze region. For example, identifying the set of candidate objects may include identifying a plurality of objects in the gaze region and selecting the set of candidate objects from the plurality of objects based on a selection criteria. The selection criteria may include a proximity of an object to the electronic device, a size of an object, either absolute or relative, or other information such as a context of the request.

At block 508, a determination may be made whether the target object can be identified from the set of candidate objects. Determining whether the target object can be identified from the set of candidate objects may include associating a confidence score with each one of the set of candidate objects, the confidence score indicating a confidence that a particular one of the set of candidate objects is the target object. If the confidence score for a particular candidate object is above a threshold value, the target object may be identified. For example, if the user says “tell me more about that plant,” while looking at an area including a number of objects but only one plant, the target object may be identified with high confidence. However, if the user says “tell me more about that” as discussed above, it is unclear what the target object is. If the target object cannot be identified from the set of candidate objects, the process moves on to block 510.

At block 510, a graphical user interface may be generated allowing the user to select the target object from the set of candidate objects. As discussed and illustrated above, the graphical user interface may include a number of selectable graphical elements, each representing a corresponding candidate object.

At block 512, user input adjusting selection of a candidate object as the target object may be received. This may include interacting with the electronic device via a change in gaze, a voice command, a gesture, or any other input. As discussed above, the graphical user interface may change in response to said user input, presenting a selectable graphical element associated with a selected one of the candidate objects in a different way than the other selectable graphical elements.

At block 514, user input selecting the target object from the set of candidate objects may be received. As discussed above, the user input may be a change in the gaze of the user, a voice command, a gesture, or any other input. This may be a confirmation of the selection received in block 512 in some embodiments.

At block 516, the request may be performed with respect to the target object. As discussed above, this may include providing information related to the target object, setting a reminder related to the target object, performing an action related to the target object (e.g., turning off a smart device), etc.

If the target object can be identified from the set of candidate objects in block 508, the process skips blocks 510 and 512 and proceeds to block 514.

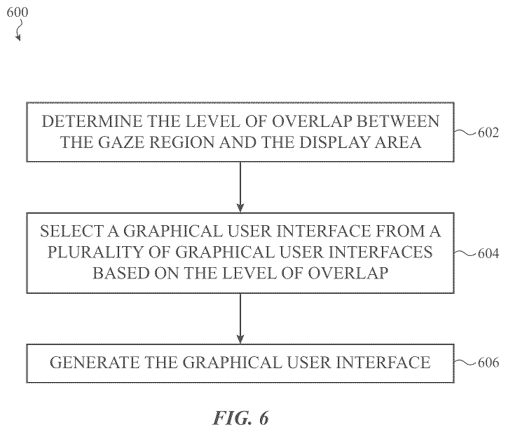

FIG. 6 is a flowchart depicting example operations of a method 600 for generating the graphical user interface as in block 510 of FIG. 5. At block 602, a level of overlap between the gaze region and a display area may be determined. As discussed above, the display area corresponds to an area on which a graphical user interface may be presented by the electronic device as viewed by a user of the electronic device. The gaze region may be completely outside the display area as in FIG. 3A, completely within the display area as in FIGS. 3B-3D, or partially within the display area as in FIG. 3E. The level of overlap between the display area and the gaze region may be used to determine the graphical user interface presented, as shown above in the aforementioned figures. Accordingly, in block 604 a graphical user interface may be selected from a plurality of graphical user interfaces based on the level of overlap between the display area and the gaze region. At block 606, the graphical user interface may be generated. Generating the graphical user interface may include providing commands to the display of the electronic device to cause the graphical user interface to be displayed.

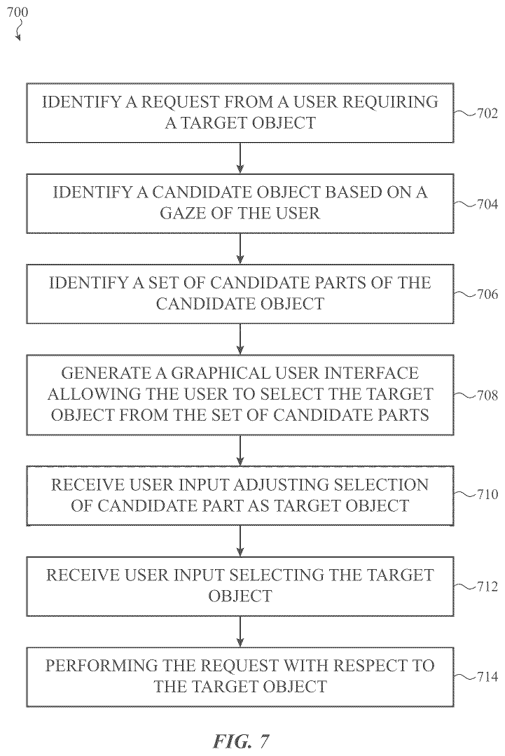

As discussed above, in some cases the target object may be part of another object. FIG. 7 is a flowchart depicting example operations of a method 700 for performing a request from a user requiring a target object that is part of another object. The operations may be performed, for example, by the electronic device 100 discussed above with respect to FIG. 1. At block 702, a request from a user requiring a target object may be identified. The request may be identified as discussed above with respect to FIG. 5.

At block 704, a candidate object may be identified based on a gaze of the user. The candidate object may be identified, for example, using one or more cameras. For example, the candidate object may be identified using computer vision techniques performed on images and/or video from the one or more cameras.

At block 706, a set of candidate parts of the candidate object may be identified. The set of candidate parts of the candidate object may also be identified, for example, using one or more cameras. In particular, the one or more candidate parts of the candidate object may be identified using computer vision techniques performed on images and/or video from the one or more cameras.

At block 708, a graphical user interface may be generated allowing the user to select the target object from the set of candidate parts. As discussed and illustrated above, the graphical user interface may include a number of selectable graphical elements, each representing one of the set of candidate parts. Notably, the set of candidate parts may include the candidate object, as well as various parts of the candidate object.

At block 710, user input adjusting selection of a candidate part as the target object is received. This may include interacting with the electronic device via a change in gaze, a voice command, a gesture, or any other input. As discussed above, the graphical user interface may change in response to said user input, presenting a selectable graphical element associated with a selected one of the candidate parts in a different way than the other selectable graphical elements.

At block 712, user input selecting the target object from the set of candidate parts may be received. As discussed above, the user input may be a change in the gaze of the user, a voice command, a gesture, or any other input. This may be a confirmation of the user input provided in block 710 in some embodiments.

At block 714, the request may be performed with respect to the target object. As discussed above, this may include providing information related to the target object, setting a reminder related to the target object, or performing an action related to the target object.

These foregoing embodiments depicted in FIGS. 1-7 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

1. A method of operating an electronic device, comprising:
identifying a request from a user of the electronic device, the request requiring a target object in a field of view of a camera of the electronic device; and
in response to the request:
determining a gaze region in the field of view corresponding to a gaze of the user;
identifying a set of candidate objects located in the gaze region;
generating a graphical user interface at a display of the electronic device, the graphical user interface allowing the user to select the target object from the set of candidate objects;
receiving user input selecting the target object from the set of candidate objects; and
in response to the user input, performing the request with respect to the target object.

2. The method of claim 1, wherein the request is a voice command from the user.

3. The method of claim 1, wherein identifying the set of candidate objects comprises:
identifying a plurality of objects in the gaze region; and
selecting the set of candidate objects from the plurality of objects based on a selection criteria.

4. The method of claim 3, wherein the selection criteria includes a proximity of an object to the electronic device.

5. The method of claim 3, wherein the selection criteria is based on a context associated with the request.

6. The method of claim 3, wherein:
the request specifies an object type of the target object; and
the selection criteria is a determination whether a type of an object matches the specified object type.

7. The method of any of claim 1, wherein the user input selecting the target object from the set of candidate objects comprises a change in the gaze of the user corresponding to a part of the graphical user interface associated with the target object.

8. The method of claim 1, further comprising:
determining if the target object can be identified in the set of candidate objects; and
in response to a determination that the target object can be identified, performing the request with respect to the target object, wherein generating the graphical user interface at the display is in response to a determination that the target object cannot be identified.

9. The method of claim 1, wherein the graphical user interface includes a set of selectable icons, each of the set of selectable icons corresponding to one of the set of candidate objects.

10. The method of claim 9, wherein at least one of the set of selectable icons includes an image of the corresponding one of the set of candidate objects taken by the camera.

11. The method of claim 9, wherein at least one of the set of selectable icons includes an image chosen from a plurality of images in a database based on the corresponding one of the set of candidate objects.

12. The method of claim 9, wherein at least one of the set of selectable icons includes a shape corresponding to a shape of the corresponding one of the set of candidate objects.

13. A non-transitory computer-readable medium comprising instructions, which when executed by at least one computing device, cause the at least one computing device to perform operations comprising the steps of claim 1.

14. An electronic device, comprising:
a camera having a field of view;
a gaze tracker configured to detect a gaze of a user;
a display having a display area positioned to overlap at least a portion of the gaze field of view; and
a processor operably coupled to the gaze tracker and the display and configured to:
identify a request from a user of the electronic device, the request requiring a target object in the field of view of the camera; and
in response to the request:
determine a gaze region in the field of view corresponding to the gaze of the user;
identify a set of candidate objects located in the gaze region;
generate a graphical user interface at a display of the electronic device, the graphical user interface allowing the user to select the target object from the set of candidate objects;
receive user input selecting the target object from the set of candidate objects; and
in response to the user input, perform the request with respect to the target object.

15. The electronic device of claim 14, wherein the request is a voice command from the user.

16. The electronic device of claim 14, wherein identifying the set of candidate objects comprises:
identifying a plurality of objects in the gaze region; and
selecting the set of candidate objects from the plurality of objects based on a selection criteria.

17. The electronic device of claim 16, wherein the selection criteria includes a proximity of an object to the electronic device.

18. The electronic device of claim 16, wherein the selection criteria is based on a context associated with the request.

19. The electronic device of claim 16, wherein:
the request specifies an object type of the target object; and
the selection criteria is a determination whether a type of an object matches the specified object type.

20. The electronic device of claim 14, wherein the user input selecting the target object from the set of candidate objects comprises a change in the gaze of the user corresponding to a part of the graphical user interface associated with the target object.

21-57. (canceled)
